(19) United States
(12) Patent Application Publication
(10) Pub. No.: US 2017/0192883 A1
(43) Pub. Date: Jul. 6, 2017

(54) TESTING METHOD FOR SDK AND AN ELECTRONIC DEVICE, A TESTING SYSTEM THEREOF

(71) Applicant: MediaTek Singapore Pte. Ltd., Singapore (SG)

(72) Inventors: Shuwei YUAN, Chengdu City (CN); Ko-Chien CHEN, Dongshan Township (TW)

(21) Appl. No.: 15/134,835

(22) Filed: Apr. 21, 2016

(30) Foreign Application Priority Data
Jan. 6, 2016 (CN) 201610006328.3

(51) Int. Cl. G06F 11/36

(52) U.S. Cl. CPC G06F 11/3688; G06F 11/3684

(57) ABSTRACT

A testing method for SDK and an electronic device and a testing system thereof are provided. The testing method for SDK includes steps of receiving a testing case of software development kit described by a markup language, wherein the testing case includes at least one functional block; acquiring the at least one functional block of the testing case; and transmitting the at least one functional block to a measured device.

### CROSS REFERENCE TO RELATED APPLICATIONS

This Application claims priority of China Patent Application No. 201610006328.3,filed on Jan. 6, 2016, the entirety of which is incorporated by reference herein.

### BACKGROUND OF THE INVENTION

Field of the Invention

The invention generally relates to a software development kit testing technology, and more particularly, to a testing method for software development kit and an electronic device and a testing system thereof.

Description of the Related Art

Currently, SDK (Software Development Kit) usually refers to a set of development tools used by the software engineer to establish application software for particular software packages, software frameworks, hardware platforms, operating systems, etc. SDK is widely applied in current electronic devices, such as smart phones, tablet PCs, game consoles, wearable devices and so on. For example, when a wearable device is loaded with SDK, due to the limited computation and storage ability of the wearable device and not having an input interface (such as a display screen, keyboard and so on), testing the SDK applications on such device may involve a great degree of difficulty.

In addition, In currently existing technologies, the programming language (such as C language) is commonly used to build SDK testing cases, so it requires senior software engineers to ensure the quality of testing cases. However, due to cost considerations, it is difficult to expand or increase test personnel, resulting in higher maintenance and revision costs on the testing cases.

### BRIEF SUMMARY OF THE INVENTION

Accordingly, embodiments of the invention provide testing methods for SDK and devices and testing systems thereof to effectively solve the above problems.

In order to solve the above problems, one embodiment of the present invention provides a testing method for software development kit (SDK), the testing method comprising: receiving a testing case of the SDK described by a markup language, wherein the testing case includes at least one functional block; acquiring the at least one functional block of the testing case and transmitting the at least one functional block to a measured device.

In order to solve the above problems, another embodiment of the present invention provides a testing device for testing a software development kit (SDK), wherein the testing device comprises: a test processing module for receiving a testing case of SDK described by a markup language, wherein the testing case includes at least one functional block; and a first communication module coupled with the test processing module for transmitting the at least one functional block of the testing case to a measured device.

In order to solve the above problems, another embodiment of the present invention provides a testing method for SDK, comprising: receiving at least one functional block included in a testing case described by a markup language; testing the testing case according to a calling sequence of the at least one functional block included in the testing case; and acquiring a testing result of the testing case and transmitting the testing result to a testing device.

In order to solve the above problems, another embodiment of the present invention provides a device under testing for software development kit (SDK) testing, comprising: a second communication module for receiving at least one functional block included in a testing case described by a markup language; a testing firmware module coupled with the second communication module for acquiring a calling sequence of the at least one functional block included in the testing case; and a testing module coupled with the testing firmware module for testing the testing case according to the acquired calling sequence, acquiring a testing result of the testing case and transmitting the testing result to a testing device through the second communication module.

In order to solve the above problems, another embodiment of the present invention provides a testing system, which includes the above-mentioned testing device and device under testing.

The beneficial effects of the embodiments are: compared with the situation of the prior art, the present invention receives a testing case of SDK described by a markup language, wherein the testing case includes at least one functional block; acquiring the at least one functional block of the testing case and transmitting the at least one functional block to a measured device, wherein the testing case uses the markup language for description without a need for programing language so that the testing language is simple and is easy to maintain and revise and low costs.

### BRIEF DESCRIPTION OF DRAWINGS

The invention can be more fully understood by reading the subsequent detailed description and examples with references made to the accompanying drawings, wherein:

FIG. 1 is a flowchart of a testing method for SDK according to the first embodiment of the invention;

FIG. 2 is a schematic diagram illustrating a structure of a testing system based on the testing method of FIG. 1; and

FIG. 3 is a schematic diagram illustrating a structure of a testing system according to the first embodiment of the invention.

### DETAILED DESCRIPTION OF THE INVENTION

The present invention will now be combined with the implementation of the accompanying drawings, were clear examples of technical solutions of the present invention, fully described, it is clear that the described embodiments are merely part of the embodiments of the present invention, but not all embodiments. Based on the embodiments of the present invention, all other embodiments of the ordinary skilled in the art without creative efforts shall be made available, are within the scope of the present invention protected.

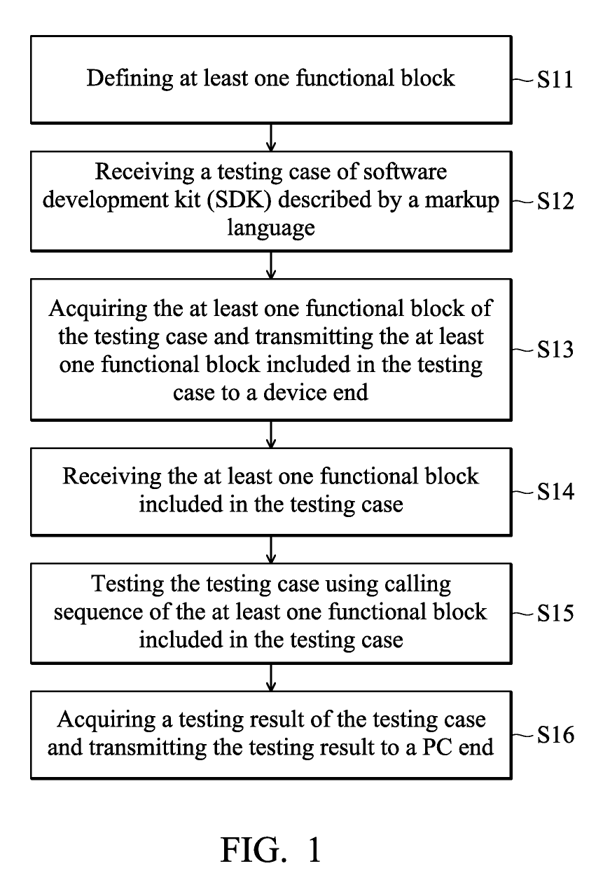

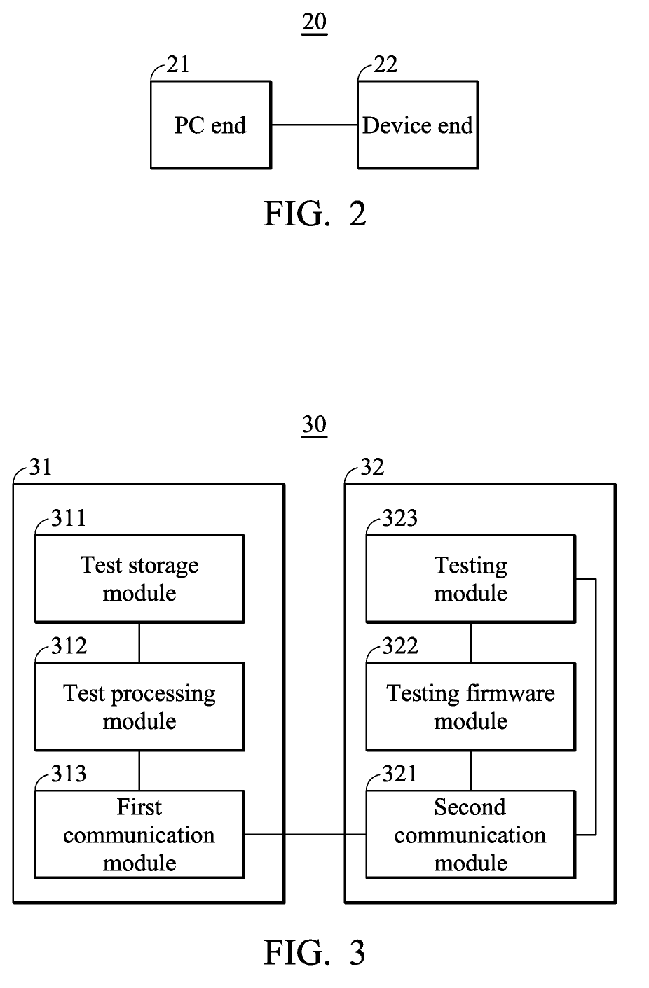

Please referring to FIGS. 1-2, FIG. 1 is a flowchart of a testing method for SDK according to the first embodiment of the invention; while FIG. 2 is a schematic diagram illustrating a structure of a testing system based on the testing method of FIG. 1. Testing method of this embodiment is tested based on the testing system 20, as shown in FIG. 2, the testing system 20 includes PC (Personal Computer) end 21 and a device end 22 coupled with the PC end 21. The PC end 21 is connected with the device end 22 via UART (Universal Asynchronous Receiver Transmitter). In the present invention, the PC end 21 is served as a testing device, the device end 22 is served as the device under testing. In other embodiments, one of ordinary skill in the art can also use other ways to connect the PC end 21 and the device end 22, such as USB (Universal Serial Bus), Bluetooth, WiFi and other connections. It should be noted that, the PC end 21 may be a computer, tablet computer, server, smartphone; the device end 22 may be a smart phone, wearable device, smart bracelet, bluetooth headset and other electronic devices. The foregoing description is only for illustrative purposes and the invention is not limited thereto.

As shown in FIG. 1, the testing method of the present embodiment comprises the steps of:

Step S11: defining at least one functional block, wherein the at least one functional block is associated with the testing;

Wherein, the PC end 21 can pre-define at least one functional block, namely the PC end 21 pre-sets at least one functional block according to the needs of testers, wherein the at least one functional block is described by a markup language.

Step S12: receiving a testing case (Test case) of SDK described by a markup language; specifically, the PC end 21 receives the testing case of SDK described by a markup language, and the testing case consists of at least two functional blocks. Tester inputs the testing case described by the markup language at the PC end 21, and testers can also self-define the testing case using the markup language, wherein the markup language is preferably be XML (Extensible Markup Language). It should be noted that the above step of receiving the testing case can comprise receiving the at least one predetermined functional block, or inputting the testing case of SDK including the at least one functional block by a developer to the testing device (for example, the PC end 21).

In other embodiments, one of ordinary skill in the art can also use other markup languages, such as HTML (HyperText Markup Language), XHTML (The Extensible Hyper Text Markup Language), WML (Wireless Markup Language), SMIL (Synchronized Multimedia Integration Language), SGML (Standard Generalized Markup Language), MathML (Mathematical Markup Language) or XAML (eXtensible Application Markup Language) etc.

Step S13: acquiring at least one functional block included in the testing case, and transmitting the at least one functional block included in the testing case to the device end 22 (i.e., the device under test or measured device);

Wherein, the PC end 21 acquires the at least one functional block included in the testing case and transmits the at least one functional block included in the testing case to the device end 22.

Step S14: receiving the at least one functional block included in the testing case;

Wherein, the device end 22 receives at least one functional block included in the testing case.

Step S15: testing the testing cases according to calling sequences of the at least one functional block included in the testing case;

Wherein, the device end 22 acquires the calling sequences of the at least one functional block included in the testing case and tests the testing cases according to the calling sequences of the at least one functional block.

Step S16: acquiring a testing result of the testing case, and transmitting the testing result to the PC end 21 (i.e., testing device);

Wherein the device end 22 acquires the testing result of a testing case and transmits the testing result to the PC end 21 after testing of the testing case is completed.

Compared with the situation of the prior art, the tester in this embodiment can enter the testing case described by the markup language at the PC end 21 or directly combine and load at least one functional block predefined by the PC end 21. As the markup language is being used, familiarity with programming language is unnecessary. Hence, the testing language is simple and is easy to maintain and revise at low costs. Additionally, the tester can self-define the testing cases to enhance test quality.

The present invention also provides a second embodiment of the testing method for SDK, which is described on the basis of the first embodiment of the testing method disclosed. Each of the at least one functional block further includes a plurality of basic functional modules. The PC end 21 acquires at least one basic functional module of each of the at least one functional block, and transmits the at least one basic functional module included in the testing case to the device end 22.

In step S14, the device end 22 receives the at least one basic functional module included in the testing case.

In step S15, the device end 22 reconstructs calling sequences of multiple basic functional modules in the testing case and testing the testing case according to the calling sequences reconstructed. Preferably, the device end 22 can reconstruct the calling sequences of multiple basic functional modules in the testing case by using graph algorithms, that is, the device end 22 reconstructs the calling sequences of APIs (Application Programming Interface) in the testing case by using the graph algorithms to precisely control the execution of APIs of SDK, so as to achieve a goal for testing the testing case.

The testing method disclosed in this embodiment can support functional testing cases, cross testing cases, interruption or preemption testing cases, concurrent testing cases, pressure testing cases, and performance testing cases. In addition, SDK's APIs can be set to be loop execution in the testing cases to achieve multi-thread concurrent execution, conditional execution, and synchronous or asynchronous execution. It supports different SDK's API calls to share return values and parameters of the SDK.

How to implement a concurrent testing case by the above testing method is described below. The concurrent testing case specifically for the tester is to test a SP (Smart Phone) that is listening to songs through a Bluetooth headset while performing a WiFi scanning to achieve a goal for listening to the songs via the Bluetooth headset and connecting to the WiFi network at the same time.

The step of inputting the testing case described by XML at the PC end 21 may include the following steps:

Step 1: initiating a protocol of Bluetooth headset (test target), wherein the protocol of the Bluetooth headset is preferably an a2dp (Advanced Audio Distribution Profile) protocol, and the protocol is used for transferring music data between the Bluetooth headset and the SP;

Step 2: initiating an a2dp protocol connection to directly establish a transmission connection between the Bluetooth headset and the SP;

Step 3: the SP plays music through the Bluetooth headset, and the PC end 21 prompts the user to play music in the SP;

Step 4: the SP initiates a WiFi connection. Wherein Steps 4 and 3 can occur simultaneously.

The PC end 21 acquires functional blocks included in the concurrent testing case, wherein steps 1through 4 for the concurrent testing case are the functional blocks included in the concurrent testing case, namely one step refers to one functional block, for example, step 1 is the functional block 1, step 2 is the functional block 2, step 3 is the functional block 3 and step 4 is the functional block 4.

Each functional block comprises a plurality of basic functional modules, wherein the basic functional modules are implemented to perform the step 1, step 2, step 3 and step 4 of the concurrent testing case, and the basic functional modules can be called multiple times in different testing cases. The PC end 21 transmits the basic functional modules in the concurrent testing case to the device end 22.

In the functional block 1, the initialization the protocol of the Bluetooth headset is performed, the corresponding basic functional module is used to initialize the Bluetooth headset protocol, e.g., the basic functional module bt_a2dp_init is configured to initialize the a2dp protocol. The device end 22 stores functions corresponding to the basic functional module, and calls the function corresponding to the basic functional module bt_a2dp_init to achieve initialization of Bluetooth headset protocol.

In the functional block 2, initialization of an a2dp protocol connection is performed, wherein the corresponding basic functional module is used to initiate a connection, such as the basic functional module bt_a2dp_connect, the basic functional module bt_a2dp_connect particularly comprises:

Sub-step 1: the device end 22 calls the bt_a2dp_connect_request function to initiate an a2dp protocol connection request;

Sub-step 2: the device end 22 calls the bt_a2dp_connect_state function to initiate a function for querying the status of the a2dp protocol, to confirm whether the Bluetooth headset and the SP are in connection status;

Sub-step 3: the device end 22 calls the bt_a2dp_connect_cnf function and returns a2dp protocol connection results;

Sub-step 4: the device end 22 calls the bt_a2dp_connect_state function to initiate the function for querying the status of the a2dp protocol, to confirm whether the Bluetooth headset and the SP are still in connection status;

Sub Step 5: the device end 22 calls the bt_a2dp_device_get_role function to initiate the function for querying the status of the a2dp protocol, to confirm whether the device end role of the Bluetooth headset is correct after connecting to the SP.

In the functional block 3, the SP plays music through the Bluetooth headset, in which the basic functional module is bt_a2dp_accept_play_remote_music which is configured to play the audio data stream sent by the SP in the Bluetooth headset. The basic functional module bt_a2dp_accept_play_remote_music particularly comprises:

Sub-step 1: the device end 22 calls the bt_a2dp_start_streaming_ind function to determine whether the audio data stream has arrived the Bluetooth headset;

Sub-step 2: the device end 22 calls the bt_a2dp_start_streaming_response function, such that the Bluetooth headset starts playing the audio data stream.

In the functional block 4, the SP initiates a WiFi connection, in which the basic functional module is WiFi connect which is configured to initiate scanning of a WiFi hotspot, and transmit the connection. The basic functional module WiFi_connect particularly comprises:

Sub-step 1: the device end 22 calls the wifi_init function for initiating a wifi init;

Sub-step 2: the device end 22 calls the wifi_scan function for scanning a WiFi hotspot;

Sub-step 3: the device end 22 calls the wifi_check_status function to check whether the current status is not connected;

Sub-step 4: the device end 22 calls the wifi_connect function for initiating the WiFi connection;

Sub-step 5: the device end 22 calls the wifi_check_status function for confirming whether the current status is connected again.

After the testing of the above concurrent testing case is completed, the device end 22 acquires the test result and transmits the test result to the PC end 21.

How to implement interruption testing cases by the above testing method is described below. The interruption testing case specifically for the tester is to test a situation where an incoming call is received when the SP (auxiliary testing device) is using a Bluetooth headset (testing target) to play music such that the music of the Bluetooth headset is being interrupted to output ringer tone music and then the call is received using the Bluetooth headset.

The step of inputting the testing case described by XML at the PC end 21 may include the following steps:

Step 1: initiating a HFP (Hands-free Profile) protocol of the Bluetooth headset, wherein the HFP protocol of the Bluetooth headset is used for performing telephone services between the Bluetooth headset and the SP, and telephone services include making or receiving calls, voice calls and so on.

Step 2: initiating the a2dp protocol of the Bluetooth headset for transferring music data between the Bluetooth headset and the SP;

Step 3: initiating the a2dp protocol connection for directly establishing an a2dp connection between the Bluetooth headset and the SP;

Step 4: initiating the HFP protocol connection for directly establishing a HFP protocol connection between the Bluetooth headset and the SP, wherein steps 3 and 4 may occur simultaneously;

Step 5: the Bluetooth headset plays music, and the PC end 21 prompts the user to play music in the SP;

Step 6: incoming call is received, the Bluetooth headset plays ringer tone music, and then answers the call, wherein the PC end 21 prompts the user to initiate a call to the SP.

Wherein the steps 1-5 disclosed in this embodiment are similar to the steps 1-4 disclosed in the above concurrent testing case, and thus details are omitted here for brevity.

In step 6, the corresponding basic functional module is the bt_hfp accept call, which is configured to answer the incoming call, wherein the Bluetooth headset first plays music and then initializes operation for answering the call. The basic functional module bt_hfp_accept_call particularly comprises:

Sub-step 1: the device end 22 calls the bt_hfp_ciev_setup_ind function to determine ciev setup status;

Sub-step 2: the device end 22 calls the bt_hfp_audio_connect_ind function to determine whether the audio of the SP is connected to the Bluetooth headset;

Sub-step 3: the device end 22 calls the bt_hfp_ring_ind function to confirm that the SP's ringer tone indication starts, wherein implementation of this function will stop the music playing of the Bluetooth headset such that the Bluetooth headsets starts playing ringer tone;

Sub-step 4: the device end 22 calls the bt_hfp_answer_call function to initialize operation of answering the call;

Sub-step 5: the device end 22 calls the bt_hfp_answer_call_cfm function to confirm that the operation for answering the call is successfully launched;

Sub-step 6: the device end 22 calls the bt_hfp_ciev_call_ind function to confirm the call is answered;

Sub-step 7: the device end 22 calls the bt_hfp_ciev_setup_ind function to confirm the ciev setup status is switched to call answered.

After the testing of the above interruption concurrent testing case is completed, the device end 22 acquires the test result and transmits the test result to the PC end 21.

Testing methods disclosed in the present embodiment can execute a testing case for each run, thereby reducing resource consumption and achieving the testing cases automation.

Embodiment of the present invention also provides a test system, which is described on the basis of the testing method disclosed by the first embodiment. Referring to FIG. 3, the testing system 30 of this embodiment includes a PC end 31 and a device end 32 connected to the PC end 31.

The PC end 31 comprises a test storage module 311, a test processing module 312 and a first communication module 313, wherein the test processing module 312 is coupled with the test storage module 311 and the first communication module 313 is coupled with the test processing module 312.

The device end 32 comprises a second communication module 321, a testing firmware module 322 and a testing module 323. The second communication module 321 is connected to the first communication module 313, wherein the second communication module 321 is preferably connected to the first communication module 313 via the UART connection. The testing firmware module 322 is coupled with the second communication module 321 and the testing module 323 is respectively coupled with the testing firmware module 322 and the second communication module 321.

The test storage module 311 is used for storing at least one predetermined functional block, wherein the at least one functional block is associated with the SDK testing. The test processing module 312 is used for receiving the at least one functional block included in the testing case, wherein the at least one functional block may be derived from the test storage module 311 or from the developer's input. The first communication module 313 is used for transmitting the at least one functional block included in the testing case to the second communication module 321.

The second communication module 321 is used for receiving the at least one functional block included in the testing case. The testing firmware module 322 is used for acquiring calling sequences of the at least one functional block included in the testing case. The testing module 323 is used for testing the testing case to acquire the test result of the testing case according to the calling sequences and transmitting the test result to the first communication module 313 through the second communication module 321.

The markup language is preferably XML. In other embodiments, one of ordinary skill in the art may also employ other markup languages, e.g., HTML, XHTML, WML, SMIL, SGML, MathML or XAML. It should be noted that, since each of the at least one functional block may comprise at least one basic functional module, so the calling sequences can be refined for the calling sequences of each basic functional module. As it has already been introduced previously, details are omitted here for brevity.

Compared with the situation of the prior art, the testers in this embodiment can enter the testing cases described by markup languages at the PC end 21. Familiarity with programing language is unnecessary. The language is simple and easy to maintain and revise at low costs. In addition, the testers can self-define testing cases to enhance test quality.

The testing method disclosed in this embodiment can support functional testing cases, cross testing cases, interruption or preemption testing cases, concurrent testing cases, pressure testing cases, and performance testing cases. In addition, SDK's APIs can be set to be loop execution in the testing cases to achieve multi-thread concurrent execution, conditional execution, and synchronous or asynchronous execution. It supports different SDK's API calls to share return values and parameters of the SDK.

In summary, the testers of the present invention can enter the testing cases described by markup languages at the PC end such that familiarity with programing language is unnecessary and the testing language is simple and easy to maintain and revise at low costs. In addition, the testers can self-define the testing case or combine preset functional blocks to form the testing cases, thereby enhancing test quality. Furthermore, each testing case operated can reduce resource consumption and achieve testing case automation.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A testing method for software development kit (SDK), comprising:
receiving a testing case of the SDK described by a markup language, wherein the testing case includes at least one functional block;
acquiring the at least one functional block of the testing case and transmitting the at least one functional block to a measured device.

2. The testing method of claim 1, wherein each of the at least one functional block consists of a plurality of basic functional modules, and each of the at least one functional block includes calling sequences of the plurality of basic functional modules.

3. The testing method of claim 1, wherein the step of receiving the testing case of the SDK described by the markup language further comprises:
predefining the at least one functional block at a testing device or inputting, by the developer, the testing case included of the at least one functional block to the testing device.

4. The testing method of claim 1, wherein the markup language comprises XML, HTML, XHTML, WML, SMIL, SGML, MathML or XAML.

5. The testing method of claim 1, wherein the measured device is connected with a testing device via UART, USB, Bluetooth, or WiFi, and the testing method is implemented in the testing device.

6. The testing method of claim 3, wherein the step of predefining the at least one functional block at the testing device further comprises: storing the at least one functional block in a test storage module of the testing device.

7. A testing device for testing a software development kit (SDK), wherein the testing device comprises:
a test processing module for receiving a testing case of SDK described by a markup language, wherein the testing case includes at least one functional block; and
a first communication module coupled with the test processing module for transmitting the at least one functional block of the testing case to a measured device.

8. The testing device of claim 7, wherein each of the at least one functional block consists of a plurality of basic functional modules, and each of the at least one functional block includes calling sequences of the plurality of basic functional modules.

9. The testing device of claim 7, further comprising a test storage module coupled with the test processing module for storing the at least one functional block predefined and outputting the at least one functional block to the test processing module when testing is required.

10. The testing device of claim 7, wherein the markup language comprises XML, HTML, XHTML, WML, SMIL, SGML, MathML or XAML.

11. The testing method of claim 7, wherein the measured device is connected with the testing device via UART, USB, Bluetooth, or WiFi.

12. A testing method for software development kit (SDK), comprising:
receiving at least one functional block included in a testing case described by a markup language;
testing the testing case according to a calling sequence of the at least one functional block included in the testing case; and
acquiring a testing result of the testing case and transmitting the testing result to a testing device.

13. The testing method of claim 12, wherein each of the at least one functional block consists of a plurality of basic functional modules, and each of the functional block includes calling sequences of the plurality of basic functional modules.

14. The testing method of claim 13, wherein the step of testing the testing case according to the calling sequence of the at least one functional block included in the testing case further comprises:
reconstructing the calling sequences of the plurality of basic functional modules on the testing case and testing the testing case according to the reconstructed calling sequences.

15. The testing method of claim 12, wherein a measured device is connected with the testing device via UART, USB, Bluetooth, or WiFi, and the testing method is implemented in the measured device.

16. A device under testing for software development kit (SDK) testing, comprising:
a second communication module for receiving at least one functional block included in a testing case described by a markup language;
a testing firmware module coupled with the second communication module for acquiring a calling sequence of the at least one functional block included in the testing case; and
a testing module coupled with the testing firmware module for testing the testing case according to the acquired calling sequence, acquiring a testing result of the testing case and transmitting the testing result to a testing device through the second communication module.

17. The device under testing of claim 16, wherein each of the at least one functional block consists of a plurality of basic functional modules, and each of the functional block includes calling sequences of the plurality of basic functional modules.

18. The device under testing of claim 16, wherein the device under testing is connected with the testing device via UART, USB, Bluetooth, or WiFi.

19. The device under testing of claim 17, wherein the testing module reconstructs the calling sequences of the plurality of basic functional modules on the testing case and tests the testing case according to the reconstructed calling sequences.
